(19) United States
(12) Patent Application Publication
(10) Pub. No.: US 2012/0217354 A1
(43) Pub. Date: Aug. 30, 2012

(54) CLAMP FOR A PIPE OR CABLE

(75) Inventors: Jan van WALRAVEN, GP Mijdrecht (NL); Marek JUZAK, Zs Mijdrecht (NL)

(73) Assignee: RAYWAL HOLDING SAS, Grenoble Cedex 2 (FR)

(21) Appl. No.: 13/358,647

(22) Filed: Jan. 26, 2012

(30) Foreign Application Priority Data
Feb. 25, 2011 (EP) 11155979.5

(51) Int. Cl. F16L 3/08

(52) U.S. Cl. 248/74.1

(57) ABSTRACT

A pipe or cable clamp for attaching a pipe or cable to a support structure, comprises a base to be mounted to the support structure, and a strap. The strap comprises two legs interconnected by a clamp portion. The base has lateral walls being provided with outwardly extending teeth and the legs of the strap, on their side facing inwards, are provided with a series of inwardly extending teeth adapted for a locking engagement with the teeth of the base to couple the strap to the base. The inwardly extending teeth and outwardly extending teeth are arranged such that during mounting, when the clamp portion is pushed towards the base, the inwardly extending teeth on the legs slide along the teeth on the base in a ratchet-like manner. In a pre-assembly state one of the legs of the strap is connected to the base by a frangible hinging connection.

### BACKGROUND OF THE INVENTION

The present invention relates to a pipe or cable clamp for attaching a pipe or a cable to a support structure. The clamp comprises a base, which is to be mounted to the support structure, and furthermore a strap. The pipe or cable can be clamped between the base and the strap. The strap comprises two legs interconnected by a clamp portion. The base has lateral walls being provided with outwardly extending teeth. The legs of the strap are provided on their side facing inwards with a series of inwardly extending teeth adapted for a locking engagement with the teeth of the base to couple the strap to the base. The inwardly extending teeth and outwardly extending teeth are arranged such that during mounting, when the clamp portion is pushed towards the base, the inwardly extending teeth on the legs slide along the teeth on the base in a ratchet-like manner

A clamp of this type is known from DE 19 09 284. In FIG. 1 of DE 19 09 284 a push-fit clamp is shown which comprises a base with an integrally formed dowel. The base can be attached to a support structure by means of a screw. The base constitutes a seat for the pipe or cable to be attached to the support structure. The clamp furthermore comprises a separate strap, which can be placed on the base and can be interconnected therewith. The strap is generally U-shaped with two parallel legs interconnected by a clamp portion that in use engages the pipe or cable. The base has on its lateral sides outwardly extending teeth. The legs of the strap have inwardly extending teeth that can cooperate with the teeth on the respective lateral sides of the base to interlock the strap with the base. In use a pipe or cable is placed on the seat of the base, after which the strap can be placed over the pipe or cable. The strap is pushed down such that the teeth on the legs slide along the teeth on the base in a ratchet-like manner. The strap is pushed down until the clamping portion of the strap engages the pipe or cable. The teeth keep the base and the strap interlocked.

Another clamp of this type is disclosed in EP 353 539. This known cable clamp has a base and a strap that are interconnected by a connection strip, which extends between the side wall of the strap and the side wall of the base. The connection strip constitutes a permanent connection between the base and the strap, both in an assembled and a pre-assembled state.

The present invention has for an object to provide an improved pipe or cable clamp.

### SUMMARY OF THE INVENTION

This object is achieved by a Pipe or cable clamp for attaching a pipe or a cable to a support structure, the clamp comprising a base, which is to be mounted to the support structure, and a strap, wherein the pipe or cable can be clamped between the base and the strap, wherein the strap comprises two legs interconnected by a clamp portion, the base has lateral walls being provided with outwardly extending teeth and the legs of the strap on their side facing inward being provided with a series of inwardly extending teeth adapted for a locking engagement with the teeth of the base to couple the strap to the base, wherein said inwardly extending teeth and outwardly extending teeth are arranged such that during mounting, when the clamp portion is pushed towards the base, the inwardly extending teeth on the legs slide along the teeth on the base in a ratchet-like manner, wherein, in a pre-assembly state, one of the legs of the strap is connected to the base by a hinging connection, which is frangible.

The clamp according to the invention has the advantage that the base and the strap of the clamp are in one piece when the clamp is mounted. The fitter therefore does not need to grab for two separate parts and assemble them. Furthermore, the frangible connection constitutes a hinging connection. Thereby the strap can then be hinged around the connection between the legs and the base and closed around the pipe or cable. When the strap is subsequently pushed down, the frangible connection is ruptured such that the legs of the strap can move along the lateral sides of the base. Thus the clamp can be easily closed around the pipe or cable and then be tightened around the pipe or cable.

In a practical embodiment the strap is generally U-shaped with the two legs substantially parallel and interconnected by the clamp portion.

In a preferred embodiment of the clamp according to the invention, at least one of the lateral walls of the base is provided with at least one transversely extending lug, wherein the frangible connection is arranged between said lug and the leg. The lug allows a good positioning of the hinging point with respect to the lateral wall of the base, such that the legs in a pre-closed state are both parallel with the lateral walls of the base.

In a preferred embodiment the frangible connection is arranged at the end of the leg.

Preferably the lateral wall has two transversely extending lugs, between which the leg of the strap can be guided.

In a possible embodiment the base below the teeth in the base is provided with at least one recess for inserting a tool to allow releasing of the locking engagement between the teeth of the base and the strap. This allows that the strap and the base can be released when necessary.

In another possible embodiment, the legs of the strap are provided with a guiding rib extending in the longitudinal direction of the leg and the lateral walls of the base are provided with a complementary guiding groove, said guiding rib in the mounted state being received in the guiding groove, or, wherein the legs of the strap are provided with a guiding groove extending in the longitudinal direction of the leg and the lateral walls of the base are provided with a complementary guiding rib which in mounted state is received in the guiding groove. The guiding ribs and grooves assure a good translational movement when the strap is pushed towards the base to tighten the clamp around a pipe or cable.

Preferably, the rib or groove on the leg and the lateral wall is arranged in the middle seen in the axial direction of the pipe or cable, and wherein the teeth on the leg and the lateral wall are arranged on either side of the groove or rib.

In a preferred embodiment the base or the clamp portion of the strap has a concave engagement surface for engaging the pipe or cable, which has a constant radius of curvature. A pipe or cable with the same radius or a smaller radius can be received in the space provided by the concave engagement surface.

In a further preferred embodiment, the clamp portion of the strap or the base has a concave engagement surface for engaging the pipe or cable, which concave engagement portion has a top portion with a constant radius of curvature and two outer portions that join the top portion, which have a greater radius of curvature than the top portion.

In yet a further preferred embodiment, the radius of curvature of the outer portions of the engagement surface of the clamp portion or the base is substantially equal to the constant radius of curvature of the engagement surface of the base or clamp portion. This shape of the engagement surface of the clamp portion is advantageous to clamp pipes or cables of different diameters, the largest diameter being the double of the radius of curvature of the engagement surface of the base and the outer portions of the engagement surface of the clamp portion. A pipe or cable of the greatest diameter will be engaged by the clamp portion on two contact regions. Smaller pipes, especially the ones with a diameter corresponding to the double of the radius of curvature of the top portion of the engagement surface, or smaller, can be engaged by said top portion. This shape ensures that the smaller pipe diameters are centred in the top portion.

The pipes or cables may in a practical embodiment have an outer diameter in the range of 12-22 mm. Common diameters used for pipes in or cables in this range are 12, 15, 18 and 22 mm. An advantageous pitch between the teeth on the legs and the teeth on the lateral walls of the base is therefore about 1.5 mm.

Another aspect of the invention relates to a pipe or cable clamp for attaching a pipe or a cable to a support structure, the push-fit clamp comprising a base, which is to be mounted to the support structure, and a strap between which the pipe or cable can be clamped, wherein the strap is generally U-shaped comprising two substantially parallel legs interconnected by a clamp portion, the base on its lateral sides being provided with outwardly extending teeth and the legs of the strap on their side facing inwards being provided with a series of inwardly extending teeth adapted for a locking engagement with the teeth of the base to couple the strap to the base, wherein said inwardly extending teeth and outwardly extending teeth are arranged such that during mounting when the clamp portion is pushed towards the base, the inwardly extending teeth on the legs slide along the teeth on the base in a ratchet-like manner, wherein the base below the teeth in the base is provided with at least one recess for inserting a tool to allow releasing of the locking engagement between the teeth of the base and the strap. This allows that the strap and the base can be released easily with a screw driver or the like when necessary.

The present invention will be elucidated in the following detailed description with reference to the drawings.

### BRIEF DESCRIPTION OF THE DRAWINGS

FIG. 1 shows a view in perspective of a preferred embodiment of pipe or cable clamp according to the invention in an open state;

FIG. 2 shows a front view of the clamp of FIG. 1;

FIG. 3 shows an elevational view from above of the clamp of FIG. 1;

FIG. 4 shows a side elevational view of the clamp of FIG. 1;

FIG. 5 shows a front view of the clamp of FIG. 1 in closed state with a pipe with large diameter clamped in it; and

FIG. 6 shows a front view of the clamp of FIG. 1 in closed state with a pipe with a small diameter clamped in it.

### DETAILED DESCRIPTION

In the following the term “pipe” or “pipe clamp” will be used. It must be understood that where “pipe” or “pipe clamp” is used, also “cable” or “cable clamp” is envisaged.

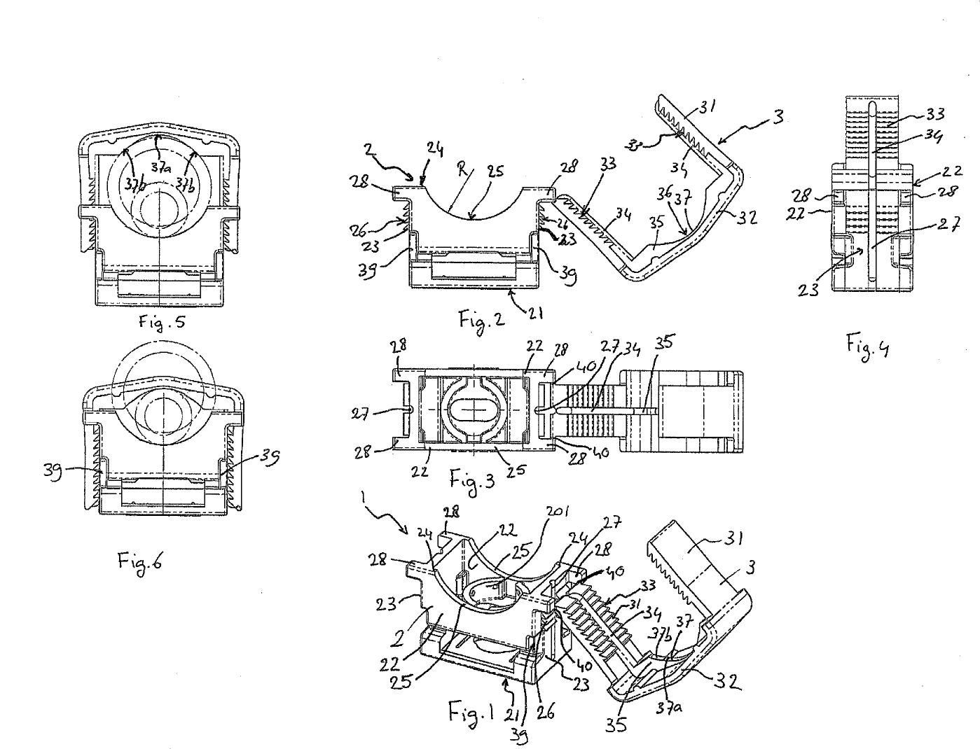

FIG. 1 shows a pipe clamp 1 comprising a base 2 and a strap 3. The pipe clamp 1 is manufactured from plastics material, preferably by means of an injection moulding process.

The base 2 is adapted to be mounted to a support structure such as a wall or ceiling. The base can also be mounted directly on a C-rail or other profiled section, or by means of a fastening element as is shown in EP 1470340. Also mounting on an adapter of the type similar to the one shown in EP 1229282 is possible. The base 2 has a bottom surface 21 in which a hole for a screw or other male fastening element is provided. There is also provided an essentially ring shaped feature 201 for inserting the end of a barrel of a nail gun. However, many ways are possible to fasten the base to a support structure, but the way the base 2 is fastened to a support structure is not essential for the present invention.

The base has two substantially parallel front walls 22, and two essential parallel lateral walls 23. The lateral walls 23 interconnect the front walls 22.

The front walls 22 have a top edge 24 which is provided with a recess providing a seat for a pipe. The recess is preferably curved and more preferably has a constant radius of curvature R. Thereby the top edge 24 of the wall 22 at the recess has a curved engagement surface 25. The lateral walls 23 are provided with a toothing 26 with outwardly extending teeth. In the example in the drawing the toothing 26 has four teeth below each other, but this may also be another number. In the middle between the front walls 22 each of the lateral walls 23 is provided with a guiding groove 27 which extends from the top edge towards the bottom of the base 22. The groove 27 extends through the toothing 26 on the lateral wall 23.

At the top corners the base 22 is provided with lugs 28. The lugs 28 extend beyond the lateral walls 23 in the direction transverse thereto, preferably perpendicular thereto. The lugs 28 in between them define a space for the legs of the strap 3 as will be described below.

The strap 3 is in the specific embodiment shown substantially U-shaped and comprises two substantially parallel legs 31 which are interconnected by a clamp portion 32. The legs 31 have a region which is provided with toothing 33 of which the teeth extend inwardly such that the can cooperate with the teeth of the toothing 26 on the lateral walls 23 of the base 2 so as to interlock the base 2 and the strap 3 (see FIGS. 5 and 6). In the middle of the legs 31 is arranged a rib 34. The rib 34 extends over the length of the leg 31 and fits in the corresponding groove 27 in the lateral wall 23 of the base 2.

On the inside of the clamp portion 32 is also provided a rib 35. This rib 35 is provided with a recess 36. The recess 36 has a curved shape whereby a concave engagement portion 37 is provided for engaging the pipe. The engagement portion 37 has a top portion 37a with a constant radius of curvature and two outer portions 37b that join the top portion 37a, which have a greater radius of curvature than the top portion 37a.

In a practical but non-limiting example the radius of curvature of the top portion 37a may be 9 mm and the radius of curvature of the outer portions 37b may be 11 mm. The radius of curvature R of the seat in the base 2 is then preferably also 11 mm. In such a pipe clamp pipes with an outer diameter in a range of 12-22 mm may be camped.

One of the legs 31 is attached at its lower end to the outer end of the lugs 28 by a frangible connection 40. The frangible connection points 40 function as a hinge when the pipe clamp 1 is mounted and closed around a pipe. The base 2 and the strap 3 of the pipe clip 1 are manufactured in one piece, by injection moulding.

In use the base can be attached to a support structure after which a pipe or cable can be placed in the seat of the base 2. The clamp 1 has then the open state as is shown in FIGS. 1-4. Then the fitter can swivel the strap around the hinging points 40 from the open state to a pre-closed state in which the strap 3 is positioned over the pipe with the clamp portion 32 extending over the pipe and the legs 31 of the strap extend substantially parallel to the lateral walls of the base 2. Then the strap 3 can be pushed downwardly, whereby the frangible connection at the points 40 is broken. Moving downwardly the teeth on the legs 31 of the strap 3 move along the teeth of the toothing 26 on the lateral walls of the base 2 like a ratchet. The strap 3 cannot be released by pulling the strap upwards, because the interlocking toothings 26 and 33 block the movement upwards.

The connection points 40 are located such that clamp is provided with a self-aligning feature of the strap 3 wherein the strap is easily swiveled to a closing position, in which the legs are aligned parallel with the laterals sides of the base. In the closing position the strap can be pushed downwards and tightened against the pipe. Advantageously the fitter does not have to take a separate strap or a strap that is connected to the base by a connection strip (cf. EP 353 539) and position the strap on the base.

In order to be able to release the strap 3 from the base 2 in the mounted state, the base is provided with a recess 39. The recess is provided just below the toothing 26 on the lateral wall of the base 2. A tool, for instance a screw driver tip can be inserted in the recess and can thereby engage the side of the leg on the inner side. Thus, by pushing the leg outwardly by means of the screw driver, the toothings 26 and 33 can be disengaged from each other and the strap 3 may be released from the base 2.

What is claimed is:

1. A pipe or cable clamp for attaching a pipe or a cable to a support structure, the clamp comprising a base, which is to be mounted to the support structure, and a strap, wherein the pipe or cable can be clamped between the base and the strap, wherein the strap comprises two legs interconnected by a clamp portion, the base has lateral walls being provided with outwardly extending teeth and the legs of the strap on their side facing inwards being provided with a series of inwardly extending teeth adapted for a locking engagement with the teeth of the base to couple the strap to the base, wherein said inwardly extending teeth and outwardly extending teeth are arranged such that during mounting, when the clamp portion is pushed towards the base, the inwardly extending teeth on the legs slide along the teeth on the base in a ratchet-like manner, wherein, in a pre-assembly state, one of the legs of the strap is connected to the base by a hinging connection, which is frangible.

2. The clamp according to claim 1, wherein the strap is generally U-shaped with the two legs substantially parallel and interconnected by the clamp portion.

3. The clamp according to claim 1, wherein at least one of the lateral walls of the base is provided with at least one transversely extending lug, wherein the frangible connection is arranged between said lug and the leg.

4. The clamp according to claim 3, wherein the lateral wall is provided with two lugs extending laterally, the legs being guided between the guiding lugs during mounting.

5. The clamp according to claim 1, wherein the frangible connection is arranged at the end of the leg.

6. The clamp according to claim 1, wherein the base below the teeth in the base is provided with at least one recess for inserting a tool to allow releasing of the locking engagement between the teeth of the base and the strap.

7. The clamp according to claim 1, wherein the legs of the strap are provided with a guiding rib extending in the longitudinal direction of the leg and the lateral walls of the base are provided with a complementary guiding groove, said guiding rib in the mounted state being received in the guiding groove, or, wherein the legs of the strap are provided with a guiding groove extending in the longitudinal direction of the leg and the lateral walls of the base are provided with a complementary guiding rib which in mounted state is received in the guiding groove.

8. The clamp according to claim 7, wherein the rib or groove on the leg and the lateral wall is arranged in the middle seen in the axial direction of the pipe or cable, and wherein the teeth on the leg and the lateral wall are arranged on either side of the groove or rib.

9. The clamp according to claim 1, wherein the base or the clamp portion of the strap has a concave engagement surface for engaging the pipe or cable, which has a constant radius of curvature.

10. The clamp according to claim 1, wherein the clamp portion of the strap or the base has a concave engagement surface for engaging the pipe or cable, which concave engagement portion has a top portion with a constant radius of curvature and two outer portions that join the top portion, which have a greater radius of curvature than the top portion.

11. The clamp according to claims 9, wherein the clamp portion of the strap or the base has a concave engagement surface for engaging the pipe or cable, which concave engagement portion has a top portion with a constant radius of curvature and two outer portions that join the top portion, which have a greater radius of curvature than the top portion, and wherein the radius of curvature of the outer portions of the engagement surface of the clamp portion or the base is substantially equal to the constant radius of curvature of the engagement surface of the base or clamp portion.

12. The clamp according to claim 1, wherein the teeth have a pitch of about 1.5 mm.

13. A pipe or cable clamp for attaching a pipe or a cable to a support structure, the clamp comprising a base, which is to be mounted to the support structure, and a strap between which the pipe or cable can be clamped, wherein the strap is generally U-shaped comprising two substantially parallel legs interconnected by a clamp portion, the base on its lateral sides being provided with outwardly extending teeth and the legs of the strap on their side facing inwards being provided with a series of inwardly extending teeth adapted for a locking engagement with the teeth of the base to couple the strap to the base, wherein said inwardly extending teeth and outwardly extending teeth are arranged such that during mounting when the clamp portion is pushed towards the base, the inwardly extending teeth on the legs slide along the teeth on the base in a ratchet-like manner, wherein the base below the teeth in the base is provided with at least one recess for inserting a tool to allow releasing of the locking engagement between the teeth of the base and the strap.

14. A pipe or cable clamp for attaching a pipe or a cable to a support structure, the clamp comprising a base, which is to be mounted to the support structure, and a strap, wherein the pipe or cable can be clamped between the base and the strap, wherein the strap comprises two legs interconnected by a clamp portion, the base has lateral walls being provided with outwardly extending teeth and the legs of the strap on their side facing inwards being provided with a series of inwardly extending teeth adapted for a locking engagement with the teeth of the base to couple the strap to the base, wherein said inwardly extending teeth and outwardly extending teeth are arranged such that during mounting, when the clamp portion is pushed towards the base, the inwardly extending teeth on the legs slide along the teeth on the base in a ratchet-like manner, wherein, in a pre-assembly state, one of the legs of the strap is connected to the base by a hinging connection, which is frangible, whereby the strap can be hinged around the connection between the leg and the base and closed around the pipe or cable, and the strap can subsequently be pushed down, whereby the frangible connection is ruptured such that the legs of the strap can move along the lateral sides of the base.

15. A pipe or cable clamp for attaching a pipe or a cable to a support structure, said clamp comprising:
a base, which is to be mounted to the support structure, said base having a seat for a pipe or cable and having lateral walls being provided with outwardly extending teeth;
a strap, comprising two legs interconnected by a clamp portion, the legs of the strap on their inwardly facing side being provided with a series of inwardly extending teeth adapted for a locking engagement with the teeth of the base to couple the strap to the base;
wherein at an upper end of one of the lateral walls of the base two laterally extending lugs are provided, and wherein an end of one of the strap legs, which is remote from the clamp portion of the strap, is connected to said lugs by two frangible hinging points,
whereby, when in use a pipe or cable is placed on the seat on the base, the strap can be hinged around the hinging points to a position in which the respective legs of the strap are aligned with the respective lateral walls of the base and the clamping portion of the strap can subsequently be pushed towards the seat, whereby the frangible hinging points are ruptured and the legs of the strap can move along the lateral sides of the base while sliding with the inwardly extending teeth on the legs along the teeth on the base in a ratchet-like manner.
